(19) United States
(12) Patent Application Publication
(10) Pub. No.: US 2015/0230145 A1
(43) Pub. Date: Aug. 13, 2015

(54) METHOD AND DEVICE FOR CELL SELECTION BETWEEN HETEROGENEOUS NETWORKS IN MOBILE COMMUNICATION SYSTEM

(71) Applicant: Samsung Electronics Co., Ltd., Suwon-si (KR)

(72) Inventor: Yong LEE, Seongnam-si (KR)

(21) Appl. No.: 14/618,331

(22) Filed: Feb. 10, 2015

(30) Foreign Application Priority Data
Feb. 10, 2014 (KR) 10-2014-0014771

(51) Int. Cl. H04W 36/26

(52) U.S. Cl. CPC H04W 36/26

(57) ABSTRACT

A method and a device for cell selection between heterogeneous networks in a wireless communication system are provided. The method includes determining whether a strength of a signal received from a serving base station is less than a reference value, acquiring location information of the mobile station when the strength of the signal is less than the reference value, and performing cell selection, between heterogeneous networks, based on the acquired location information and a reference table in which history information on cell selections performed by the mobile station is recorded.

### CROSS-REFERENCE TO RELATED APPLICATION(S)

This application claims the benefit under 35 U.S.C. §119(a) of a Korean patent application filed on Feb. 10, 2014 in the Korean Intellectual Property Office and assigned Serial number 10-2014-0014771, the entire disclosure of which is hereby incorporated by reference.

### TECHNICAL FIELD

The present disclosure relates to a mobile communication system. More particularly, the present disclosure relates to a method and device for cell selection between heterogeneous networks.

### BACKGROUND

Mobile communication systems were generally developed to provide voice services while guaranteeing a user's activity. However, mobile communication systems have gradually expanded their services to include data services as well as voice services, which have been developed to provide high speed data services at present. However, resources are lacking and users demand higher speed services in mobile communication systems currently providing services, and therefore more improved mobile communication systems are needed.

In general, a mobile station repeatedly measures conditions of base stations therearound. When a condition is satisfied, for example when the mobile station finds a base station having a greater received signal strength indication than the current serving base station, the mobile station performs a cell reselection process for the corresponding base station.

However, a Radio Frequency (RF) module used by the mobile station needs to be changed to measure conditions of adjacent base stations between heterogeneous networks. Due to this, unnecessary time and power are likely to be consumed.

In addition, although measurement and search between heterogeneous networks are performed in the idle mode, a mobile station may be out of service when the mobile station fails to operate in the idle mode for a sufficient time or when the mobile station fails to complete the measurement and search since it is moving too fast.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and device for selecting a cell between heterogeneous networks based on information on a cell to which a mobile station was previously connected and location information of the mobile station.

In accordance with an aspect of the present disclosure, a method of selecting a cell between heterogeneous networks by a mobile station in a mobile communication system is provided. The method includes determining whether a strength of a signal received from a serving base station is less than a reference value, acquiring location information of the mobile station when the strength of the signal is less than the reference value, and performing cell selection, between heterogeneous networks, based on the acquired location information and a reference table in which history information on cell selections performed by the mobile station is recorded.

In accordance with another aspect of the present disclosure, a mobile station for performing cell selection between heterogeneous networks in a mobile communication system is provided. The mobile station includes a communication unit configured to transmit a signal to or receive a signal from a base station, a storage unit configured to store a reference table in which history information on cell selections performed by the mobile station is recorded, and a controller configured to determine whether a strength of a signal received from a serving base station is less than a reference value, acquire location information of the mobile station when the strength of the signal received from the serving base station is less than the reference value, and perform cell selection, between heterogeneous networks, based on the acquired location information and the reference table.

According to the present disclosure, a mobile station selects a cell between heterogeneous networks based on information on a cell to which the mobile station was previously connected and location information thereof. Therefore, the mobile station does not have to measure the heterogeneous networks or change a running Radio Frequency (RF) module for the measurement, thereby reducing power consumption.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating an internal structure of a mobile station according to an embodiment of the present disclosure;

FIG. 2A illustrates cells corresponding to each mobile communication network and service coverage of the cells according to an embodiment of the present disclosure;

FIG. 2B illustrates an example of a structure of a reference table according to an embodiment of the present disclosure;

FIG. 3 is a flowchart illustrating an operating sequence of a mobile station according to an embodiment of the present disclosure;

FIG. 4 is a signal flow diagram illustrating a process of performing a cell selection by a mobile station according to an embodiment of the present disclosure; and

FIG. 5 is a signal flow diagram illustrating a cell selection process of a mobile station according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing the various embodiments of the present disclosure, descriptions related to technical contents which are well-known in the art to which the present disclosure pertains, and are not directly associated with the present disclosure, will be omitted. Such an omission of unnecessary descriptions is intended to prevent obscuring of the main idea of the present disclosure and more clearly transfer the main idea.

For the same reason, in the accompanying drawings, some elements may be exaggerated, omitted, or schematically illustrated. Further, the size of each element does not entirely reflect the actual size. In the drawings, identical or corresponding elements are provided with identical reference numerals.

The advantages and features of the present disclosure and ways to achieve them will be apparent by making reference to various embodiments as described below in conjunction with the accompanying drawings. However, the present disclosure is not limited to the various embodiments set forth below, but may be implemented in various different forms. The following various embodiments are provided only to completely disclose the present disclosure and inform those skilled in the art of the scope of the present disclosure, and the present disclosure is defined only by the scope of the appended claims. Throughout the specification, the same or like reference numerals designate the same or like elements.

Here, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operations to be performed on the computer or other programmable apparatus to produce a computer implemented process such that the instructions that execute on the computer or other programmable apparatus provide operations for implementing the functions specified in the flowchart block or blocks.

Each block of the flowchart illustrations may represent a module, segment, or portion of code, which includes one or more executable instructions for implementing specified logical functions. It should also be noted that in some alternative implementations, the functions noted in the blocks may occur out of the order shown. For example, two blocks shown in succession may in fact be executed substantially concurrently or the blocks may sometimes be executed in the reverse order, depending upon the functionality involved.

As used herein, the “unit” or “module” refers to a software element or a hardware element, such as a field programmable gate array (FPGA) or an application specific integrated circuit (ASIC), which performs a predetermined function. However, the “unit” or “module” does not always have a meaning limited to software or hardware. The “unit” or “module” may be constructed either to be stored in an addressable storage medium or to execute one or more processors. Therefore, the “unit” or “module” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” or “module” may be either combined into a smaller number of elements, “unit”, or “module” or divided into a larger number of elements, “unit”, or “module”. Moreover, the elements and “units” or “modules” may be implemented to reproduce one or more central processing units (CPUs) within a device or a security multimedia card.

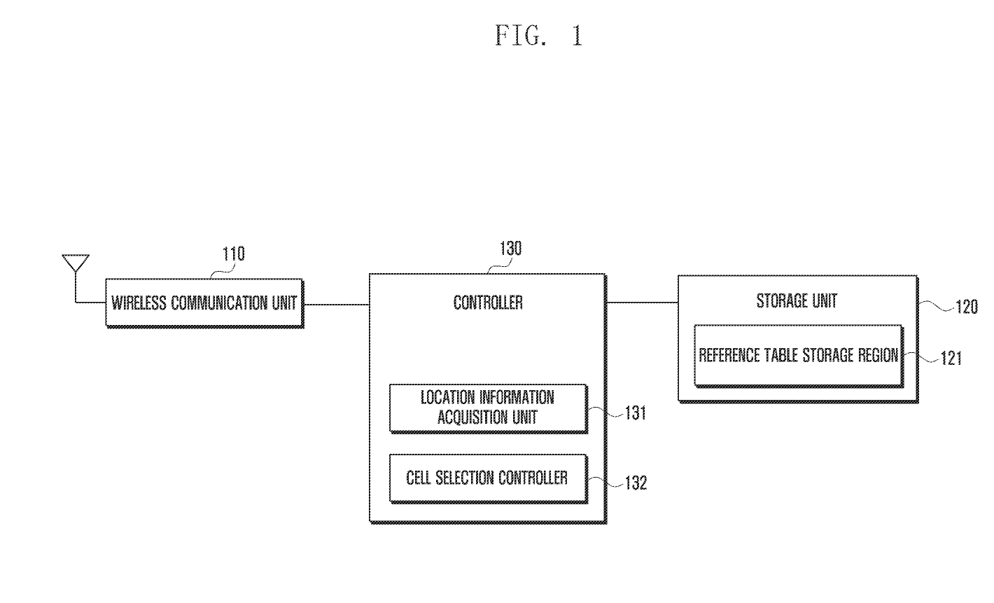

FIG. 1 is a block diagram illustrating an internal structure of a mobile station according to an embodiment of the present disclosure.

Referring to FIG. 1, a mobile station according to an embodiment of the present disclosure may include a wireless communication unit 110, a storage unit 120, and a control unit 130, which may also be referred to as a controller 130.

The wireless communication unit 110 transmits and receives corresponding data for wireless communication of the mobile station. The wireless communication unit 110 may include a radio frequency (RF) transmitter for up-converting and amplifying a frequency of a transmitted signal and an RF receiver for low noise-amplifying a received signal and for down-converting a frequency of the received signal. In addition, the wireless communication unit 110 may receive data through a wireless channel, may output the received data to the controller 130, and may transmit data, output from the controller 130, through the wireless channel.

The wireless communication unit 110, according to an embodiment of the present disclosure, may include a wireless communication module (not shown) for accessing different types of networks and performing communication. For example, the wireless communication unit 110 may include a second generation (2G) communication module for performing 2G communication, a third generation (3G) communication module for performing 3G communication, and/or a fourth generation (4G) communication module for performing 4G communication. Here, the 2G, 3G, and 4G communications may refer to communications corresponding to mobile communication networks according to different standards. The different standards may be distinguished by a frequency band and a maximum transmission speed. The wireless communication unit 110 may also be referred to as a transmission unit, a reception unit, or a transciever unit.

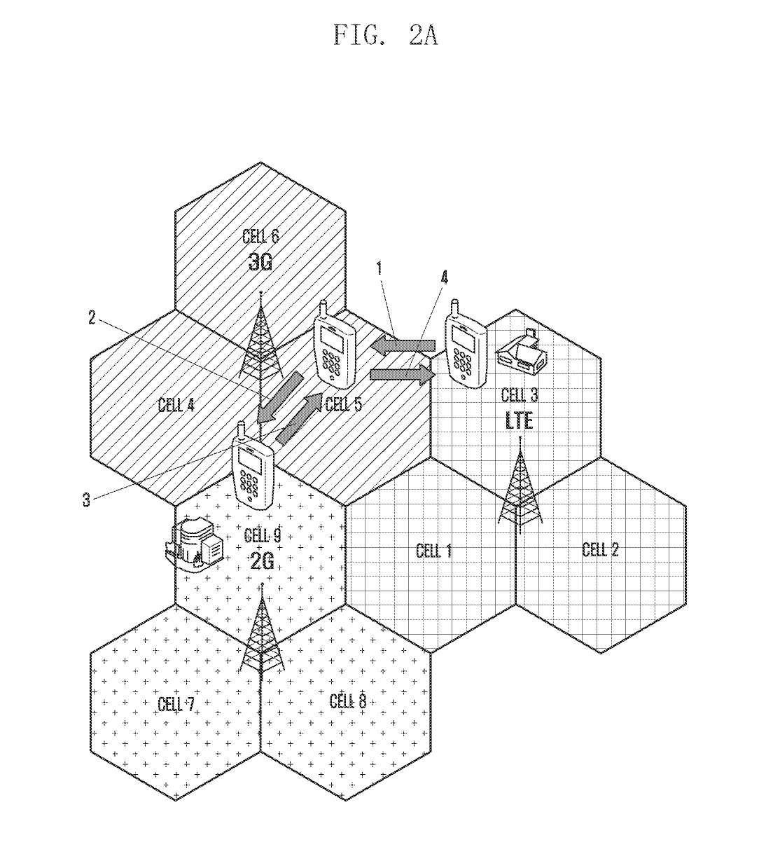

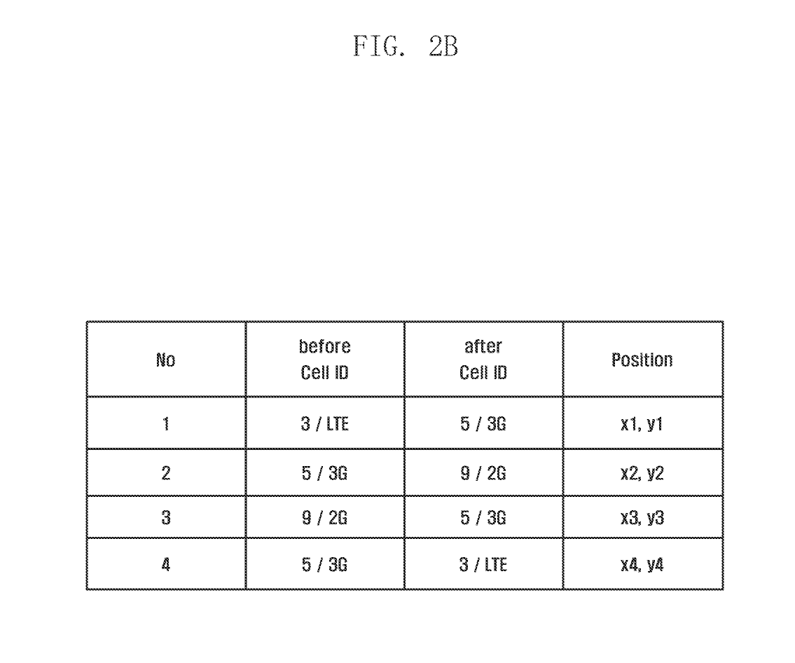

The storage unit 120 may store programs and data used for operations of the mobile station and may be divided into a program region and a data region (not shown). The storage unit 120, according to an embodiment of the present disclosure, may further include a reference table storage region 121. A cell selection history according to the location of the mobile station may be stored in the reference table. The reference table will be described in detail with reference to FIG. 2B.

The controller 130 may further include a location information acquisition unit 131 and a cell selection controller 132.

FIG. 2A illustrates cells corresponding to each mobile communication network and service coverage of the cells according to an embodiment of the present disclosure.

Referring to FIG. 2A, cell 7, cell 8, and cell 9 are included in a 2G mobile communication network. Cell 4, cell 5, and cell 6 are included in a 3G mobile communication network. Cell 1, cell 2, and cell 3 are included in a 4G Long Term Evolution (LTE) mobile communication network.

Mobile station may select and/or reselect a cell based on locations, which may be a respective location of a mobile station, of the mobile stations. In this case, the cell may be selected in a homogeneous or heterogeneous network. For example, when a mobile station moves from cell 1 to cell 2, the mobile station reselects cell 2 in the homogeneous network since both cells 1 and 2 are included in the LTE mobile communication network. In contrast, when the mobile station moves from cell 3 to cell 5, the mobile station selects cell 5 in the heterogeneous network since cell 3 is included in the LTE mobile communication network and cell 5 is included in the 3G mobile communication network.

In order to describe an embodiment of the present disclosure, the mobile station is assumed to move along one or more of path 1, path 2, path 3, and path 4.

FIG. 2B illustrates an example of a structure of a reference table according to an embodiment of the present disclosure.

Referring to FIG. 2B, a record table may be created and updated according to assumed movement paths of the mobile station according to an embodiment of the present disclosure.

Referring to FIGS. 2A and 2B, when the mobile station moves along path 1, the mobile station may perform cell selection from cell 3 in the LTE mobile communication network to cell 5 in the 3G mobile communication network. The mobile station records, in the record table, the history of the mobile station performing the cell selection from cell 3 to cell 5. If the record table has not been created in advance, the mobile station may create a record table and record the first cell selection history in the created record table. As shown in FIG. 2B, the cell selection history of the mobile station according to path 1, the location (x1, y1) of the mobile station, the cell information 3/LTE before the cell selection, and the cell information 5/3G after the cell selection, may be stored in the record table.

When the mobile station moves along path 2, the mobile station may perform cell selection from cell 5 in the 3G mobile communication network to cell 9 in the 2G mobile communication network. The mobile station records, in the record table, the history of the mobile station performing the cell selection from cell 5 to cell 9. As shown in FIG. 2B, the cell selection history of the mobile station according to path 2, the location (x2, y2) of the mobile station, the cell information 5/3G before the cell selection, and the cell information 9/2G after the cell selection, may be stored in the record table.

When the mobile station moves along path 3 again, the mobile station may perform cell selection from cell 9 in the 2G mobile communication network to cell 5 in the 3G mobile communication network. The mobile station records, in the record table, the history of the mobile station performing the cell selection from cell 9 to cell 5. As shown in FIG. 2B, the cell selection history of the mobile station according to path 3, the location (x3, y3) of the mobile station, the cell information 9/2G before the cell selection, and the cell information 5/3G after the cell selection, may be stored in the record table.

When the mobile station moves along path 4 again, the mobile station may perform cell selection from cell 5 in the 3G mobile communication network to cell 3 in the LTE mobile communication network. The mobile station records, in the record table, the history of the mobile station performing the cell selection from cell 5 to cell 3. As shown in FIG. 2B, the cell selection history of the mobile station according to path 4, the location (x4, y4) of the mobile station, the cell information 5/3G before the cell selection, and the cell information 3/LTE after the cell selection, may be stored in the record table.

The mobile station may record and store, in the record table, cell selection histories periodically or aperiodically, for a preset period of time, or as many times as a preset number.

The mobile station performs cell selection between heterogeneous networks based on the record table. A procedure for cell selection will be described below.

The controller 130 may control an overall operation of the elements of the mobile station. For example, when the mobile station performs a cell selection between heterogeneous networks, the controller may control a series of processes for the cell selection between the heterogeneous networks on the basis of information on a cell to which the mobile station has previously attached and location information of the mobile station. To this end, the controller 130 may further include the location information acquisition unit 131 and the cell selection controller 132.

The location information acquisition unit 131 acquires the location information of the mobile station. Although the location information acquisition unit 131 may be a global positioning system (GPS) according to an embodiment of the present disclosure, the location information acquisition unit 131 is not necessarily limited thereto. For example, the mobile station may also acquire the location information thereof through a wireless local area network (LAN) or a mobile communication base station, such as a macro base station.

The location information acquisition unit 131 may periodically or aperiodically acquire the location information of the mobile station. For example, the location information acquisition unit 131 may acquire the location information of the mobile station when the strength of a signal received from a serving base station is less than a threshold value, which may be a stored value and/or a preconfigured value.

The cell selection controller 132 may control a cell selection procedure, or in other words, may control a cell selection process and/or operation, between heterogeneous networks on the basis of location information and a record table of the mobile station. For example, when it is determined that the strength of a signal which the mobile station receives from the serving base station is less than a reference value, which may be a stored value and/or a preconfigured value, the cell selection controller 132 may acquire location information of the mobile station through the location information acquisition unit 131. The cell selection controller 132 may control a cell selection between heterogeneous networks on the basis of the acquired location information of the mobile station and the reference table in which the history information on the cell selections performed by the mobile station has been recorded.

Although the controller 130 includes the separate blocks and the respective blocks perform different functions, the present disclosure is not necessarily limited thereto. For example, the controller 130 may also directly perform the function which the cell selection controller 132 performs.

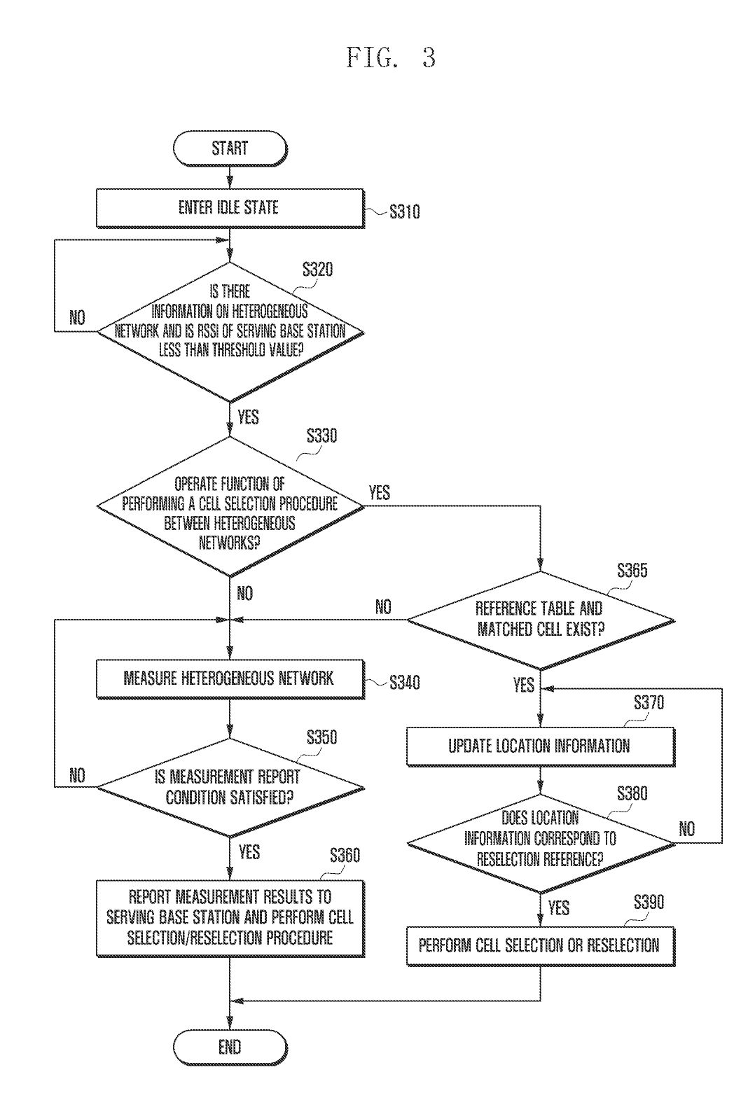

FIG. 3 is a flowchart illustrating an operating sequence of a mobile station according to an embodiment of the present disclosure.

In operation S310, a mobile station detects an entrance to an idle state. The mobile station may enter the idle state when not performing communication with a serving base station for a predetermined period of time.

In operation S320, the mobile station determines whether information on an adjacent heterogeneous network has been received from the serving base station. The information on the adjacent heterogeneous network may be transmitted through system information blocks 6, 7, and 8 transmitted from the serving base station. When receiving the information on the adjacent heterogeneous network in operation S320, the mobile station determines whether a received signal strength indication (RSSI) for the serving base station is less than a threshold value, which may be a stored value and/or a preconfigured value.

When it is determined that the RSSI for the serving base station is less than the threshold value, the mobile station proceeds to operation S330 to determine whether to operate a function of performing a cell selection procedure between heterogeneous networks according to an embodiment of the present disclosure. The function of performing the cell selection procedure between heterogeneous networks according to an embodiment of the present disclosure may include a function of performing a cell selection procedure between heterogeneous networks based on a record table.

When not operating the function of performing the cell selection procedure between heterogeneous networks according to an embodiment of the present disclosure, the mobile station proceeds to operation S340 to measure heterogeneous networks. In such a case, the mobile station may also make a measurement for other frequency bands or other adjacent base stations of a homogeneous network as well as of the heterogeneous networks.

In operation S350, the mobile station determines whether a measurement report condition is satisfied, based on the measurement results. For example, when a difference between the received signal strength indication for the serving base station and the received signal strength indication for one or more of other base stations in the heterogeneous networks is greater than or equal to a reference value, which may be a stored value and/or a preconfigured value, the mobile station may determine that the measurement report condition has been satisfied.

When the measurement report condition is not satisfied, the mobile station proceeds to operation S340 to continue to measure the heterogeneous networks.

When the measurement report condition is satisfied, the mobile station may proceed to operation S360 to report the measurement results to the serving base station and to perform a cell selection procedure or a cell reselection procedure. The mobile station may determine a presence or absence of a reference table, and when the reference table is not present, may create a reference table. The mobile station records information on the cell selection in the reference table. The information on the cell selection may include location information of the mobile station corresponding to a cell selection time point, cell information before the cell selection, and cell information after the cell selection.

When it is determined in operation S330 that the function of performing the cell selection procedure between heterogeneous networks according to an embodiment of the present disclosure is to be operated, the mobile station proceeds to operation S365 to determine a presence or absence of a reference table and a matched cell, or in other words, to determine whether the reference table exists and whether the matched cell exists. When the reference table exists, the mobile station determines whether location information corresponding to the current location thereof is present in the reference table. For example, when the location information recorded in the reference table is (10, 10) and the current location information of the mobile station is (9, 9), it may be determined that the location information recorded in the reference table and the current location information of the mobile station correspond to each other. The determination is based on the assumption that the mobile station is more likely to move to the location (10, 10), which may be referred to as a matched cell.

When the location information corresponding to the current location of the mobile station is present in the reference table, or in other words, if the record table exists and the matched cell exists, the mobile station proceeds to operation S370 to update the location information of the mobile station.

The mobile station proceeds to operation S380 to determine whether the updated location information of the mobile station corresponds to a cell selection reference, which may be a value. For example, when a difference between the updated location information of the mobile station and arbitrary location information of the mobile station recorded in the reference table is within a distance, which may be a stored value and/or a preconfigured value, it may be determined that the cell selection reference has been satisfied, or in other words, that the updated location information of the mobile station corresponds to the cell selection reference.

When it is determined that the cell selection reference has been satisfied, the mobile station proceeds to operation S390 to perform cell selection or reselection based on the reference table. For example, the mobile station may perform cell selection between heterogeneous networks based on the reference table.

The procedure will be described with reference to FIG. 2.

First, it is assumed that the record table in which the cell selection history is recorded, as is illustrated in FIG. 2B, has been stored in the mobile station.

In addition, it is assumed that the difference between the current location information of the mobile station and the location information (x1, y1) in the record table of FIG. 2B is within a distance, which may be a stored value and/or a preconfigured value, and the mobile station currently connects with cell 3.

According to the record table, when the strength of the received signal, or in other words, the RSSI, from cell 3 is less than or equal to a reference value, which may be a stored value and/or a preconfigured value or less, the mobile station is more likely to move from cell 3 to cell 5.

Therefore, according to an embodiment of the present disclosure, when the strength of the received signal from cell 3 is weakened, the mobile station performs cell selection for cell 5 based on the record table, without separately measuring the heterogeneous networks.

Consequently, the mobile station does not have to change a running RF module, or in other words, does not have to change a current operating and/or active RF module, so as to perform a measurement for heterogeneous networks. In addition, the mobile station does not perform the measurement for the heterogeneous networks, and therefore, can reduce power consumption thereof.

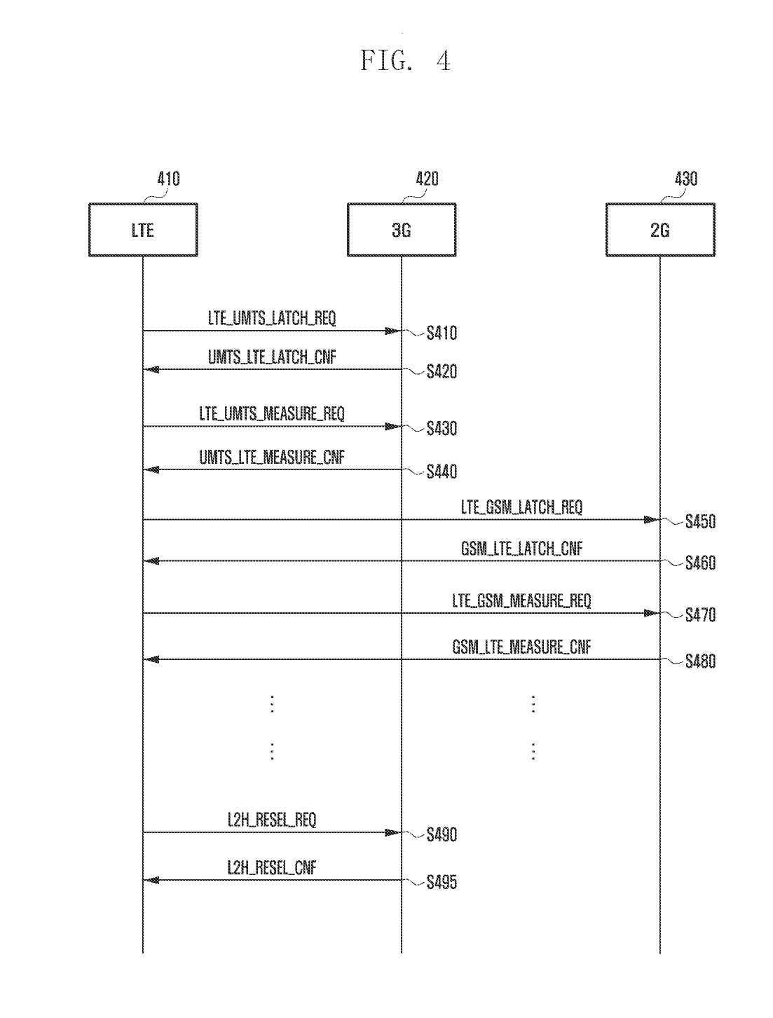

FIG. 4 is a signal flow diagram illustrating a process of performing cell selection by a mobile station according to an embodiment of the present disclosure.

Referring to FIG. 4, LTE 410 may denote an LTE communication module for performing LTE communication, 3G 420 may denote a 3G communication module for performing 3G communication, and 2G 430 may denote a 2G communication module for performing 2G communication.

In operation S410, the LTE communication module 410 requests timing information for measuring a 3G frequency from the 3G communication module 420, or in other words, the LTE communication module 410 may transmit a LTE_UMTS_LATCH_REQ message to the 3G communication module 420. Then, in operation S420, the 3G communication module 420 informs the LTE communication module 410 of the timing information for measuring a 3G frequency, or in other words, the 3G communication module 420 may transmit a UMTS_LTE_LATCH_CNF message to the LTE communication module 410.

When measurement timing arrives, the LTE communication module 410 instructs measurement of a 3G network based on the received timing information, in operation S430 or in other words, the LTE communication module 410 may transmit a LTE_UMTS_MEASURE_REQ message to the 3G communication module 420. The 3G communication module 420 measures channel states of frequencies corresponding to the 3G network and transmits the measurement results to the LTE communication module 410, in operation S440 or in other words, the 3G communication module 420 may transmit a UMTS_LTE_MEASURE_CNF message to the LTE communication module 410.

In the same way, the LTE communication module 410 requests timing information, or in other words, transmits a LTE_GSM_LATCH_REQ message, for measuring a 2G frequency from the 2G communication module 430, in operation S450. Then, in operation S460, the 2G communication module 430 informs, or in other words, transmits a GSM_LTE_LATCH_CNF message to, the LTE communication module 460 of the timing information for measuring a 2G frequency.

When measurement timing arrives, the LTE communication module 460 instructs measurement of a 2G network, or in other words, transmits a LTE_GSM_MEASURE_REQ message, based on the received timing information, in operation S470. The 2G communication module 430 measures channel states of frequencies corresponding to the 2G network and transmits the measurement results, or in other words, transmits a GSM_LTE_MEASURE_CNF message, to the LTE communication module 410, in operation S480.

As described above, the communication modules of the mobile station may acquire the channel measurement information of the heterogeneous networks through the information exchange therebetween.

For example, when the channel measurement results for the 3G mobile communication network are most satisfactory, the mobile station may perform a cell selection procedure using the 3G network through operation 5490, by transmitting a L2H_RESEL_REQ from the LTE communication module 410 to the 3G communication module 420, and through operation 5495, by transmitting a L2H_RESEL_CNF message from the 3G communication module 420 to the LTE communication module 410, based on the channel measurement information for each heterogeneous network.

As described previously, according to the related art, when the received signal strength indication for the serving base station is weakened, the channel states for the heterogeneous networks are measured, and the cell selection procedure is performed using, or in other words, is performed to select, the most satisfactory heterogeneous network based on the measurement results. Accordingly, the running communication module has to be changed to measure the channel states for the heterogeneous networks, and due to power consumption in the measurement process, the mobile station may consume a large amount of power.

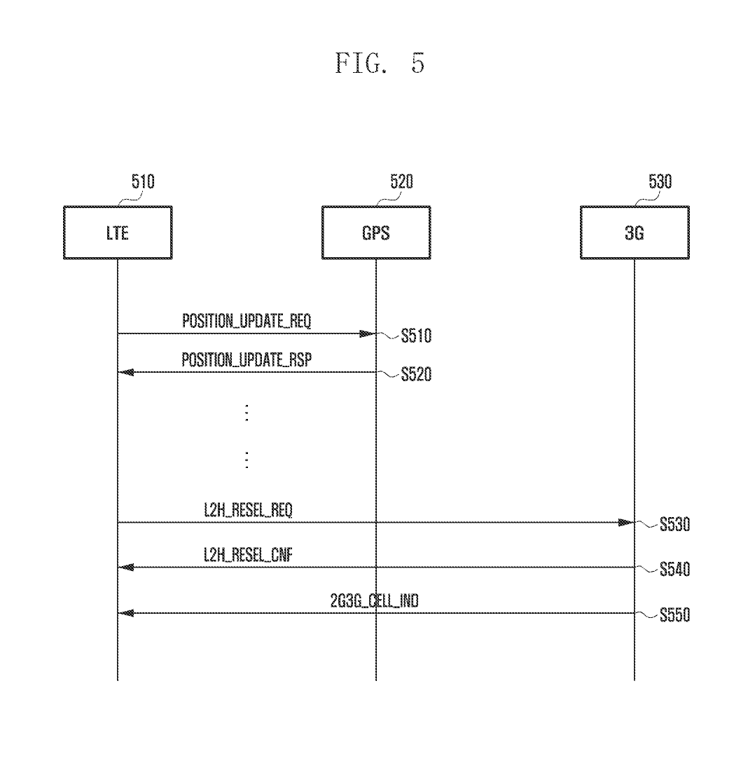

A cell selection process according to an embodiment of the present disclosure for addressing the problems in the related art will be described with reference to FIG. 5.

FIG. 5 is a signal flow diagram illustrating a cell selection process of a mobile station according to an embodiment of the present disclosure.

Referring to FIG. 5, LTE 510 may denote an LTE communication module for performing LTE communication, GPS 520 may denote a GPS module for acquiring location information of a mobile station, and 3G 530 may denote a 3G communication module for performing 3G communication.

When a particular condition is satisfied, for example when the strength of a received signal from, or in other words, an RSSI of, a serving base station is reduced to a particular threshold value or less, the LTE communication module 510 may request, or in other words, may transmit a POSITION_UPDATE_REQ message to, the GPS module 520 to update the current location information of the mobile station, in operation 5510.

In operation 5520, the GPS module 520 acquires the current location information of the mobile station and transfers the acquired information, or in other words, may transmit a POSITION_UPDATE_RSP message, to the LTE communication module 510.

Although the location information of the mobile station is updated when the received signal strength indication for the serving base station is reduced to the particular threshold value or less, the present disclosure is not necessarily limited thereto. For example, the mobile station may also periodically update the location information thereof.

Thereafter, referring to a reference table, the mobile station determines whether location information corresponding to the identified location information of the mobile station is present in the reference table. In addition, the mobile station determines whether the received signal strength indication for the serving base station is consistently maintained at the level of the particular threshold value or less for a predetermined period of time.

When the location information corresponding to the location information of the mobile station is present in the reference table and the received signal strength indication for the serving base station is consistently maintained at the level of the particular threshold value or less for the predetermined period of time, the mobile station makes a control to directly perform a cell selection procedure based on the reference table.

For example, as in operation 5530, the mobile station may control the 3G communication module 530 to configure the 3G network as a cell selection target and may request, or in other words, may transmit a L2H_RESEL_REQ message to, the 3G communication module 530 to perform a cell selection procedure. Then, the 3G communication module 530 transmits an acknowledgement message corresponding to the request, or in other words, a L2H_RESEL_CNF message, to the LTE communication module 510, in operation 5540.

The 3G communication module 530 performs the cell selection procedure for the 3G network and thereafter, reports the performance of the cell selection procedure, or in other words, transmits a 2G3G_CEL_IND message, to the LTE communication module 510, in operation S550.

According to an embodiment of the present disclosure, the mobile station does not have to measure heterogeneous networks or change a running RF module for the measurement, thereby reducing power consumption.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of selecting a cell between heterogeneous networks by a mobile station in a mobile communication system, the method comprising:
determining whether a strength of a signal received from a serving base station is less than a reference value;
acquiring location information of the mobile station when the strength of the signal is less than the reference value; and
performing cell selection, between heterogeneous networks, based on the acquired location information and a reference table in which history information on cell selections performed by the mobile station is recorded.

2. The method of claim 1, wherein the reference table comprises at least one of the location information of the mobile station, cell information recorded before the performing of the cell selection based on the acquired location information, or cell information recorded after the performing of the cell selection based on the acquired location information.

3. The method of claim 2, wherein the cell information recorded before the performing of the cell selection and the cell information recorded after the performing of the cell selection are based on cells related to the heterogeneous networks.

4. The method of claim 1, further comprising receiving information on the heterogeneous networks from the serving base station.

5. The method of claim 4, wherein the information on the heterogeneous networks is received through a system information block.

6. The method of claim 1, further comprising, after the determining of whether the strength of the signal received from the serving base station is less than the reference value:
performing measurement for the heterogeneous networks when the strength of the signal is less than the reference value;
determining whether the cell selection between the heterogeneous networks is needed based on the measurement result;
performing the cell selection between the heterogeneous networks when the cell selection between the heterogeneous networks is determined to be needed; and
storing the performance result in the reference table.

7. The method of claim 6, wherein the cell selection is determined to be needed if the measurement for the heterogeneous networks results in a strength of a signal received from one of the heterogeneous networks is greater than the strength of the reference value.

8. The method of claim 1, further comprising:
acquiring the location information of the mobile station according to a period; and
performing the cell selection between the heterogeneous networks based on the location information of the mobile station and the reference table.

9. A mobile station for performing cell selection between heterogeneous networks in a mobile communication system, the mobile station comprising:
a communication unit configured to transmit a signal to or receive a signal from a base station;
a storage unit configured to store a reference table in which history information on cell selections performed by the mobile station is recorded; and
a controller configured to determine whether a strength of a signal received from a serving base station is less than a reference value, acquire location information of the mobile station when the strength of the signal received from the serving base station is less than the reference value, and perform cell selection, between heterogeneous networks, based on the acquired location information and the reference table.

10. The mobile station of claim 9, wherein the reference table comprises at least one of the location information of the mobile station, cell information recorded before the performing of the cell selection based on the acquired location information, or cell information recorded after the performing of the cell selection based on the acquired location information.

11. The mobile station of claim 10, wherein the cell information recorded before the performing of the cell selection and the cell information recorded after the performing of the cell selection are based on cells related to the heterogeneous networks.

12. The mobile station of claim 9, wherein the controller is further configured to receive information on the heterogeneous networks from the serving base station.

13. The mobile station of claim 12, wherein the information on the heterogeneous networks is received through a system information block.

14. The mobile station of claim 9, wherein the controller is further configured to:
perform measurement for the heterogeneous networks when the strength of the signal received from the serving base station is less than the reference value;
determine whether the cell selection between the heterogeneous networks is needed based on the measurement result;
perform the cell selection between the heterogeneous networks when the cell selection between the heterogeneous networks is determined to be needed; and
store the performance result in the reference table.

15. The method of claim 14, wherein the cell selection is determined to be needed if the measurement for the heterogeneous networks results in a strength of a signal received from one of the heterogeneous networks is greater than the strength of the reference value.

16. The mobile station of claim 9, wherein the controller is further configured to:
acquire the location information of the mobile station according to a period; and
perform the cell selection between the heterogeneous networks based on the location information of the mobile station and the reference table.
